(19) United States
(12) Patent Application Publication
(10) Pub. No.: US 2009/0072561 A1
(43) Pub. Date: Mar. 19, 2009

(54) Spreader Assembly

(75) Inventor: Nicholas S. Latham, Dorset (GB)

Correspondence Address: COHEN & GRIGSBY, P.C., 625 LIBERTY AVENUE, PITTSBURGH, PA, 15222-3152, US

(73) Assignee: Modulift Design and Consulting Ltd., Poole, Dorset (GB)

(21) Appl. No.: 12/282,063

(22) PCT Filed: Mar. 7, 2007
(86) PCT No.: PCT/GB2007/000797

§ 371 Date: Sep. 8, 2008

(30) Foreign Application Priority Data
Mar. 7, 2006 (GB) 0604569.4

(51) Int. Cl. B66C 1/22

(52) U.S. Cl. 294/81.2

(57) ABSTRACT

A collapsible spreader assembly (1) capable of being disassembled comprises at least two end members (3, 5), each of which comprises a lower load attachment point (25) for attachment to the load to be lifted, and an upper lifting attachment point (21) for attachment to a crane hook or the like, the spreader assembly (1) further comprising connection means for connecting the end members (3, 5) together, the connection means comprising a male spigot connector (31), and a female socket connector (41) operative to slidingly receive the male spigot connector (31) in use, each connector (31, 41) being formed with an annular load carrying face (37, 47), the plane of each load carrying face (37, 47) being perpendicular to the longitudinal axis of the assembled spreader such that, when the end members (3, 5) are connected together, the load carrying faces (37, 47) abut so as to carry the axial compression forces acting between the ends of the spreader in use.

The present invention relates to a spreader assembly of the type used to create a plurality of load attachment points from a single lifting point such as a crane hook or the like.

It has previously been proposed to provide a spreader assembly comprising a spreader strut disposed between a pair of end members, each end member being attached to part of a load to be lifted. This may be achieved using a pair of load carrying slings or the like. Each end member of the spreader assembly is also attached to a lifting sling, the lifting slings being secured to a crane hook or the like to lift the load. Thus a spreader assembly typically provides two spaced apart load attachment points from a single lifting point.

The distance that the load attachment points are spaced apart may vary in dependence upon the size and/or weight of the load to be lifted. Larger or smaller spacing can be achieved by increasing the length of spreader strut used between the two end members. The desired length can, if necessary, be achieved by connecting a plurality of spreader struts together to form a larger, composite spreader assembly.

The spreader struts and end members typically comprise mating flanges which are bolted together. This bolting process is typically time consuming, especially if many connections have to be made.

It has also been proposed to provide a fixed link between the lifting slings, the load slings, and the spreader strut, and this fixed link can generate undesired bending forces through the strut. The possibility of these forces being generated necessitates relatively high factors of safety in the design of the various spreader rig components, in particular the spreader strut diameter and material thickness used can be relatively high. This typically leads to the spreader rig components being relatively heavy and unwieldy such that the individual components are not light enough to be manually handled by operators in the work place.

It has been proposed to provide a threaded connection between spreader components but when the components are assembled together the threads carry a significant portion of the axial compression load that is generated by the slings and which acts between the ends of the spreader assembly, To ensure such a structure is strong enough to cope with axial compression loads carried in this way, the components and the threaded connection have to be relatively substantially which again leads to a relatively high weight of component, preventing manual handling. Lighter materials have been proposed to alleviate the weight of such a proposal but such materials add expense, as does the machining of the threads on each component.

According to a first aspect of the invention there is provided a collapsible spreader assembly capable of being disassembled, the spreader assembly comprising at least two end members, each of which comprises a lower load attachment point for attachment to the load to be lifted, and an upper lifting attachment point for attachment to a crane hook or the like, the spreader assembly further comprising connection means for connecting the end members together, the connection means comprising a male spigot connector, and a female socket connector operative to slidingly receive the male spigot connector in use, each connector being formed with an annular load carrying face, the plane of each load carrying face being perpendicular to the longitudinal axis of the assembled spreader such that, when the end members are connected together, the load carrying faces abut so as to carry the axial compression forces acting between the ends of the spreader in use.

Preferably each end member comprises an elongate strut portion, each strut portion being formed with a respective connector, the elongate strut portion of each end member projecting away from the attachment points of that end member.

Preferably the strut portion of one end member is formed with a male spigot connector and the strut portion of the other end member is formed with a female socket connector.

Preferably the spreader assembly further comprises at least one intermediate spreader strut provided with connection means comprising a male spigot connector at one end of the strut, and a female socket connector at the opposed end of the strut, such that the connectors on each opposed end of the strut can be connected, in use, to a connector on a respective end member.

Preferably a plurality of intermediate spreader struts are provided, each strut being provided with connection means comprising a male spigot connector at one end of the strut, and a female socket connector at the opposed end of the strut.

Preferably the portion of each connector adjacent the annular load carrying face of that connector is of greater diameter than the diameter of the intermediate spreader strut and/or the strut portion of the end member. Preferably the male connector and the female connector of each connection means are formed with transverse through bores adapted to receive, in use, a transverse locking pin. The through bores and locking pin are operative to resist relative rotation of the connected spreader components about the longitudinal axis of the assembled spreader.

Preferably the diameter of the through bores is greater than the diameter of the locking pin such that the axial compression forces acting, in use, on the assembled spreader do not act through the locking pin.

Preferably the end members and intermediate spreader strut(s) are formed from a steel material. Most preferably the steel material comprises a density of 7.80 g/cm³.

Preferably the ratio of the lifting capacity of the assembled spreader rig to the weight of the assembled spreader is in the range 200:1 to 1000:1.

According to a second aspect of the invention there is provided a spreader kit to enable a spreader to be assembled in a plurality of different lengths, the kit comprising at least two end members, each of which comprises a lower load attachment point for attachment to the load to be lifted, and an upper lifting attachment point for attachment to a crane hook or the like, and a plurality of spreader struts, connection means being provided for connecting the end members and/or spreader struts together, the connection means comprising a male spigot connector, and a female socket connector operative to slidingly receive the male spigot connector in use, each connector being formed with an annular load carrying face, the plane of each load carrying face being perpendicular to the longitudinal axis of the assembled spreader such that, when the end members and/or spreader struts are connected together, the load carrying faces abut so as to carry the axial compression forces acting between the ends of the spreader in use.

According to a third aspect of the invention there is provided a spreader strut for a collapsible spreader assembly capable of being disassembled, the assembly comprising at least two end members, each of which comprises a lower load attachment point for attachment to the load to be lifted, and an upper lifting attachment point for attachment to a crane hook or the like, the spreader strut comprising connection means for connecting the spreader strut to another spreader strut and/or to the end members, the connection means comprising a male spigot connector, and a female socket connector operative to slidingly receive the male spigot connector in use, each connector being formed with an annular load carrying face, the plane of each load carrying face being perpendicular to the longitudinal axis of the assembled spreader such that, when the spreader strut is connected to other spreader struts and/or end members, the load carrying faces abut so as to carry the axial compression forces acting between the ends of the spreader in use.

Other aspects of the present invention may include any combination of the features or limitations referred to herein.

The present invention may be carried into practice in various ways, but embodiments will now be described by way of example only with reference to the accompanying drawings in which:

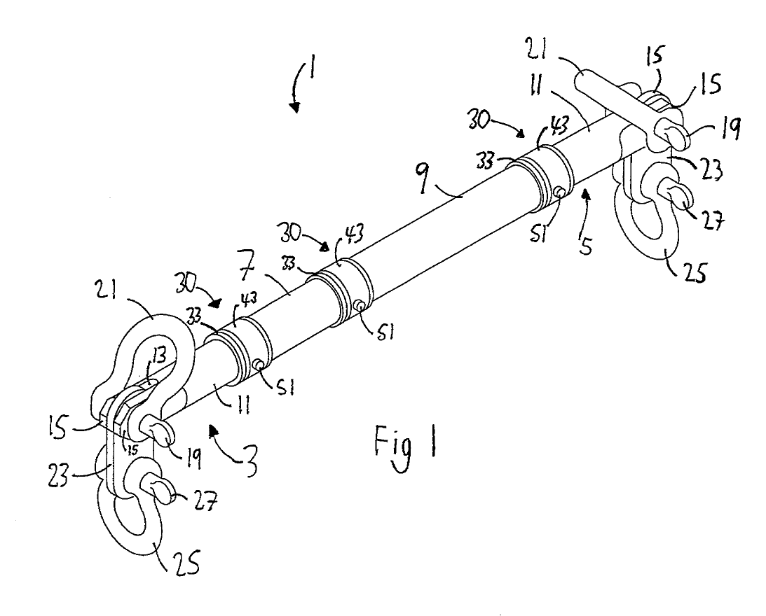

FIG. 1 is a perspective view of an assembled spreader assembly in accordance with the present invention; and

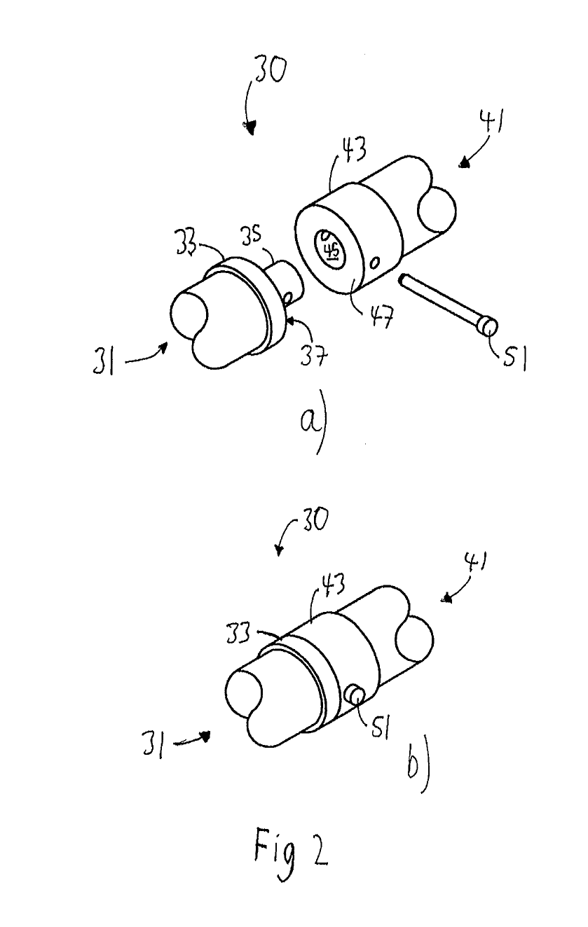

FIG. 2a and FIG. 2b are perspective views of connection means of the spreader assembly of FIG. 1 in a connected and disconnected condition.

Referring to the Figures, a spreader assembly 1 comprises two end members 3, 5 that are interconnected by two intermediate spreader struts 7, 9.

The end member 3 comprises a circular diameter strut portion 11 one end of which is formed with a slot 13 defined between two spaced apart fingers 15.

An aperture 17 is formed in each finger 15 and a pin 19 is provided which extends through the apertures 17 and the slot 13. The pin 19 secures the end member 3 to an upper, lifting shackle 21 for attachment to a crane hook or the like via an appropriate sling (not shown).

The pin also secures the end member 3 to a connecting plate 23, the upper end of which is received in the slot 13. The lower end of the connecting plate 23 is connected to a lower, load shackle 25, again via a suitable pin 27. The load shackle 25 is attached in use to part of the load to be lifted via an appropriate sling (not shown). The connecting plate 23 can pivot relative to the end member 3, 5 and relative to the load shackle 25, about the pins 19, 27. The connecting plate 23 thus creates a movable link between the load shackle 25, and the lifting shackle 21 and the beam portion 11.

The other end member 5 has identical features in this respect to the end member 3.

The end of the strut portion 11 of the end member 3 distal from the fingers 15 is provided with connection means comprising a male connector 31. The end of the strut portion 11 of the other end member 5 distal from the fingers 15 is provided with a female connector 41.

The male connector 31 comprises an enlarged diameter load carrying annular portion 33, the diameter of which is greater than the diameter of the strut portion 11 of the end member 3. The male connector 31 further comprises a protruding spigot 35 of lesser diameter than that of the strut portion 11. There is therefore provided an annular load absorbing face 37 which is defined by the ring of material of the annular portion 33 around the root of the spigot 35.

The female connector 41 comprises an enlarged diameter load carrying annular portion 43, the diameter of which is greater than the diameter of the strut portion 11 of the end member 5. The female connector 41 further comprises an internal socket 45 dimensioned to slidingly receive the spigot 35 of the male connector 31 with a sliding or an interference fit. There is therefore provided an annular load absorbing face 47 which is defined by the ring of material of the annular portion 33 surrounding the mouth of the socket 45.

The spigot 35 of the male connector 31 is formed with a transverse through bore 39. The enlarged diameter annular portion 43 of the female connector 41 is also formed with a transverse through bore 49. A locking pin 51 is provided for insertion through the through bores 39, 49 to lock the connectors 31, 41 together.

The spreader assembly 1, in this example, comprises two end members 3, 5, one of which is provided with a male connector 41 and the other of which is provided with a female connector 41. Each spreader strut 7, 9 is provided with connection means comprising a male connector 31 at one end of each strut 7, 9, and a female connector 41 at the other end of each strut 7, 9.

In use, the components 3, 5, 7, 9 of the spreader assembly 1 are connected together with the male spigot connection 31 of one component 3, 5, 7, 9 being slidingly received in the female socket connection 41 of the adjacent component 3, 5, 7, 9.

When so assembled the annular load absorbing faces 37, 47 of each connector 31, 41 abut and this abutment serves to carry, in use, the axial compressive forces that act on the spreader assembly 1 between the attachment points of the spreader assembly 1.

The locking pin 51 resists relative rotational movement between the spreader assembly components 3, 5, 7, 9 but does not carry the axial compressive forces, the through bores 39, 49 being of larger diameter than the diameter of the pin 51.

It will therefore be appreciated that the various spreader assembly components 3, 5, 7, 9 can be relatively easily and quickly secured together, with the annular faces of each connector 31, 41 carrying the axial compressive forces rather than these forces being carried by any other engagement between the two connectors 31, 41.

The use of the pivotable connecting plate 23 removes any bending load that might otherwise be generated between the end members 3, 5.

The components 3, 5, 7, 9 can be made light enough for each individual component to be handled manually without lifting machinery and this, together with the sliding connection between adjacent components 3, 5, 7, 9 discussed above, enables rapid assembly, modification, and disassembly of the spreader assembly 1.

Any number and length of spreader struts 7, 9 can be used—the above described embodiment is exemplary only. Indeed the end members 3, 5 could be connected directly together without use of any intermediate spreader struts 7, 9.

Furthermore it is envisaged that each end member 3, 5 could comprise the same type of connector, ie each end member 3, 5 could comprise a male connector 31 or a female connector 41. In this instance, the end members 3, 5 would have to be used with a spreader strut or struts each end of which comprised the opposite type of connector 31, 41 to that provided on the end members 3, 5. If no spreader struts are to be used, a joint member could be provided between the end members 3, 5, the joint member comprising two axially opposed connectors 31 or 41 both being of the same type and being the opposite type to those connectors 31, 41 provided on the end members 3, 5.

1. A collapsible spreader assembly capable of being disassembled, the spreader assembly comprising at least two end members, wherein each of the two end members comprises a lower load attachment point for attachment to the load to be lifted, and an upper lifting attachment point, the spreader assembly further comprising a connection means for connecting the end members together, the connection means comprising a male spigot connector, and a female socket connector operative to slidingly receive the male spigot connector in use, each connector being formed with an annular load carrying face, wherein the load carrying face of each connector is in a plane perpendicular to the longitudinal axis of the assembled spreader such that, when the end members are connected together, the load carrying faces abut so as to carry the axial compression forces acting between the ends of the spreader in use.

2. The collapsible spreader assembly of claim 1 wherein each end member comprises an elongate strut portion, each strut portion being formed with a respective connector, the elongate strut portion of each end member projecting away from the attachment points of that end member.

3. The collapsible spreader assembly of claim 2 wherein the strut portion of one end member is formed with a male spigot connector and the strut portion of the other end member is formed with a female socket connector.

4. The collapsible spreader assembly of claim 2 wherein the spreader assembly further comprises at least one intermediate spreader strut provided with connection means comprising a male spigot connector at one end of the strut, and a female socket connector at the opposed end of the strut, such that the connectors on each opposed end of the strut can be connected, in use, to a connector on a respective end member.

5. The collapsible spreader assembly of claim 4 wherein a plurality of intermediate spreader struts are provided, each strut being provided with connection means comprising a male spigot connector at one end of the strut, and a female socket connector at the opposed end of the strut.

6. The collapsible spreader assembly of claim 4 wherein the portion of each connector adjacent the annular load carrying face of that connector is of greater diameter than the diameter of the intermediate spreader strut and/or the strut portion of the end member.

7. The collapsible spreader assembly of claim 3 wherein the male connector and the female connector of each connection means are formed with transverse through bores adapted to receive, in use, a transverse locking pin, wherein the through bores and locking pin are operative to resist relative rotation of the connected spreader components about the longitudinal axis of the assembled spreader.

8. The collapsible spreader assembly of claim 7 wherein the diameter of the through bores is greater than the diameter of the locking pin such that the axial compression forces acting, in use, on the assembled spreader do not act through the locking pin.

9. The collapsible spreader assembly of claim 4 wherein the end members and intermediate spreader strut are formed from a steel material.

10. The collapsible spreader assembly of claim 9 wherein the steel material comprises a density of 7.80 g/cm³.

11. The collapsible spreader assembly of claim 1 wherein the ratio of the lifting capacity of the assembled spreader rig to the weight of the assembled spreader is in the range 200:1 to 1000:1.

12. A spreader kit to enable a spreader to be assembled in a plurality of different lengths, the kit comprising at least two end members, each of which comprises a lower load attachment point for attachment to the load to be lifted, and an upper lifting attachment point for attachment to a crane hook or the like, and a plurality of spreader struts, connection means being provided for connecting the end members and/or spreader struts together, the connection means comprising a male spigot connector, and a female socket connector operative to slidingly receive the male spigot connector in use, each connector being formed with an annular load carrying face, the plane of each load carrying face being perpendicular to the longitudinal axis of the assembled spreader such that, when the end members and/or spreader struts are connected together, the load carrying faces abut so as to carry the axial compression forces acting between the ends of the spreader in use.

13. A spreader strut for a collapsible spreader assembly capable of being disassembled, the assembly comprising at least two end members, each of which comprises a lower load attachment point for attachment to the load to be lifted, and an upper lifting attachment point for attachment to a crane hook or the like, the spreader strut comprising connection means for connecting the spreader strut to another spreader strut and/or to the end members, the connection means comprising a male spigot connector, and a female socket connector operative to slidingly receive the male spigot connector in use, each connector being formed with an annular load carrying face, the plane of each load carrying face being perpendicular to the longitudinal axis of the assembled spreader such that, when the spreader strut is connected to other spreader struts and/or end members, the load carrying faces abut so as to carry the axial compression forces acting between the ends of the spreader in use.

14. The collapsible spreader assembly of claim 3 wherein the spreader assembly further comprises at least one intermediate spreader strut provided with connection means comprising a male spigot connector at one end of the strut, and a female socket connector at the opposed end of the strut, such that the connectors on each opposed end of the strut can be connected, in use, to a connector on a respective end member.

15. The collapsible spreader assembly of claim 4 wherein the male connector and the female connector of each connection means are formed with transverse through bores adapted to receive, in use, a transverse locking pin, the through bores and locking pin being operative to resist relative rotation of the connected spreader components about the longitudinal axis of the assembled spreader.

16. The collapsible spreader assembly of claim 5 wherein the male connector and the female connector of each connection means are formed with transverse through bores adapted to receive, in use, a transverse locking pin, the through bores and locking pin being operative to resist relative rotation of the connected spreader components about the longitudinal axis of the assembled spreader.

17. The collapsible spreader assembly of claim 6 wherein the male connector and the female connector of each connection means are formed with transverse through bores adapted to receive, in use, a transverse locking pin, the through bores and locking pin being operative to resist relative rotation of the connected spreader components about the longitudinal axis of the assembled spreader.
